(19) United States
(12) Patent Application Publication
(10) Pub. No.: US 2013/0176231 A1
(43) Pub. Date: Jul. 11, 2013

(54) CAR STEREO HEAD UNIT WITH BUILT-IN WIRELESS COMMUNICATION MODULE SYSTEM

(71) Applicant: Shih-Yao CHEN, New Taipei City (TW)

(72) Inventor: Shih-Yao CHEN, New Taipei City (TW)

(21) Appl. No.: 13/346,128

(22) Filed: Jan. 9, 2012

(51) Int. Cl. G06F 3/041

(52) U.S. Cl. 345/173

(57) ABSTRACT

A car stereo head unit includes a control system coupled to the car control computer of the car carrying the car stereo head unit by a CAN BUS, a front face panel electrically coupled with the control system and providing a touchscreen, a display driver module system, an intelligent computer system module, an antenna embedded GPS receiver system and a wireless communication module system, and a FM/AM radio receiver module, a DVD/SD/USB player module, a digital TV receiver and player module and an audio output system electrically coupled to the control system. Subject to touch control through the touchscreen, the control system controls the audio output system to play sound and the touchscreen to play videos. By means of the intelligent computer system module and the wireless communication module system, the car stereo head unit is allowed for mobile phone application and internet access.

### BACKGROUND OF THE INVENTION

1. Field of the Invention

The present invention relates to car stereo head unit technology and more particularly, to a car stereo head unit with a built-in wireless communication module system for Wi-Fi/GPRS (3G/4G) wireless applications.

2. Description of the Related Art

A car stereo head unit is normally installed in the dashboard center console of a car. A low-level car stereo head unit simply has an audio/video player system for playing radio/DC/DVD and receiving/playing TV programs. Further, regular car stereo head unit designs do not provide any functions for smart mobile phone/tablet computer application functions.

A high-level car stereo head unit may be equipped with an ARM watchdog module or embedded computer system for satellite navigation.

However, these conventional car stereo head unit designs are not applicable for internet access or connectable with a smart mobile phone or tablet computer for direct wireless application.

### SUMMARY OF THE INVENTION

The present invention has been accomplished under the circumstances in view. It is main object of the present invention to provide a car stereo head unit, which has a built-in wireless communication module system, allowing for wireless applications.

To achieve this and other objects of the present invention, a car stereo head unit is installed in a dashboard center console of a car. The car stereo head unit comprises a control system, which comprises a car power converter electrically coupled to a car battery power supply system of the car to obtain the necessary working power supply from the car and a linear communication system electrically coupled to a car control computer of the car, a front face panel, which is electrically coupled with the control system, comprising a touchscreen, a display driver module system adapted for driving the touchscreen, an intelligent computer system module, an antenna embedded GPS receiver system and a wireless communication module system, a FM/AM radio receiver module electrically coupled to the control system, a DVD/SD/USB player module electrically coupled to the control system, a digital TV receiver and player module electrically coupled to the control system, and an audio output system electrically coupled to the control system. Subject to touch control through the touchscreen of the front face panel, the control system controls the audio output system to play sound and the touchscreen of the front face panel to play videos. Further, by means of the intelligent computer system module and wireless communication module system of the front pace panel, the car stereo head unit is allowed for mobile phone application and internet access.

Further, the linear communication system that electrically connects the control system to the car control computer of the car is constructed subject to CAN BUS (controller area network bus) protocol.

Further, the wireless communication module system of the front pace panel is a Wi-Fi/GPRS (3G/4G) wireless communication module system.

Based on the aforesaid innovative design, the invention achieves the following applications:
A. The car stereo head unit is equipped with a Wi-Fi/GPRS (3G/4G) wireless communication module system for wireless communication.
B. The car stereo head unit is installed in a car, a user having a Wi-Fi/GPRS (3G/4G) PIN (personal identification number) can upload or download application software, documents or emails, and link to a cloud computing data storage system.
C. By means of linking to the intelligent computer system module and wireless communication module system of the front pace panel of the car stereo head unit, a car security system provides a wireless car-tracking function.
D. By means of linking the intelligent computer system module and wireless communication module system of the front pace panel of the car stereo head unit to a host computer of a remote service center wirelessly, the remote service center can monitor the traveling of the car and directly transmit data to the car, and the car can also transmit data to the remote service center directly.
E. By means of linking the intelligent computer system module and wireless communication module system of the front pace panel of the car stereo head unit to a host computer of a car service center wirelessly, the car stereo head unit can provide a car location and condition information to the car service center wirelessly in case of a car failure.
F. By means of the intelligent computer system module and wireless communication module system of the front pace panel of the car stereo head unit, the car stereo head unit can transmit the recorded data from the drive recorder system or real-time images being currently picked up by a web camera to a remote control center or service center wirelessly, or storing recorded image data or real-time images on a cloud server.
G. By means of the intelligent computer system module and wireless communication module system of the front pace panel of the car stereo head unit, the car stereo head unit can transmit data from the car control computer to the host system of the car service center wirelessly during a car repair and maintenance work of the car, facilitating the car repair and maintenance work.
H. The application programs installed in the car stereo head unit can match with the car control computer, enabling the user to control certain functions of the car, such as the operation of the electric windows/air-conditioner, by means of the touchscreen.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a system block diagram illustrating the architecture of a car stereo head unit in accordance with the present invention.

FIG. 2 is a schematic drawing illustrating the car stereo head unit installed in the dashboard center console of a car in accordance with the present invention.

### DETAILED DESCRIPTION OF THE PREFERRED EMBODIMENT

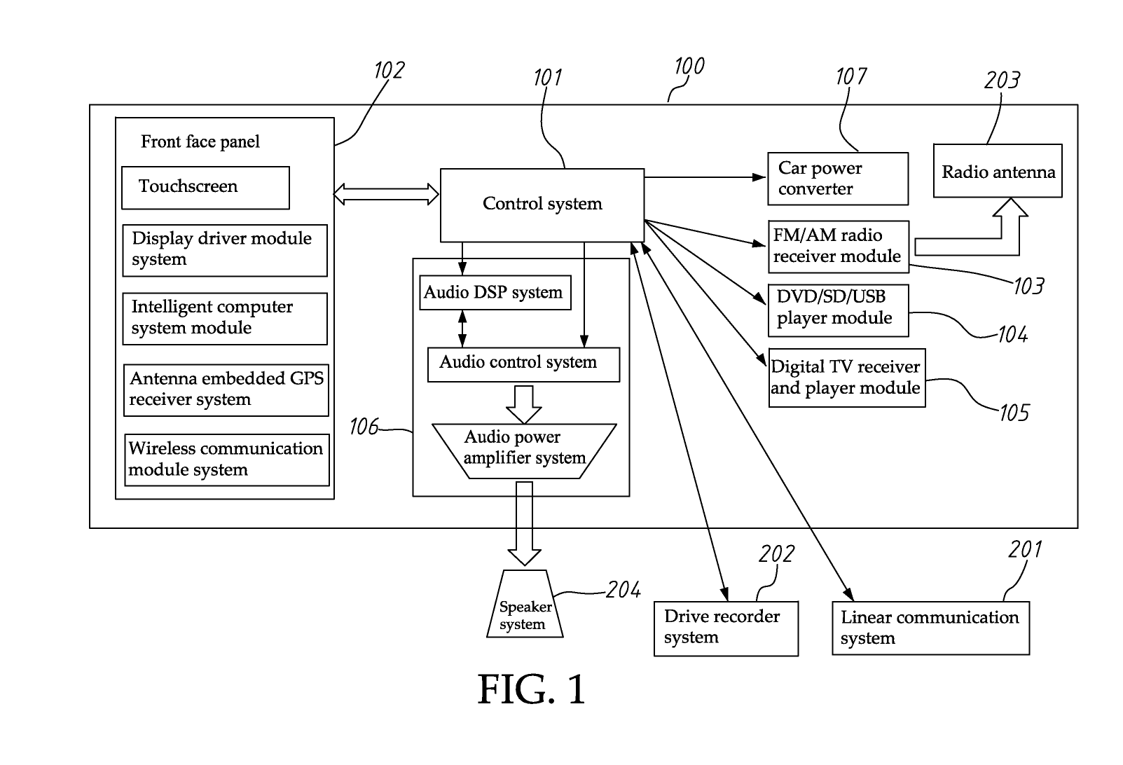

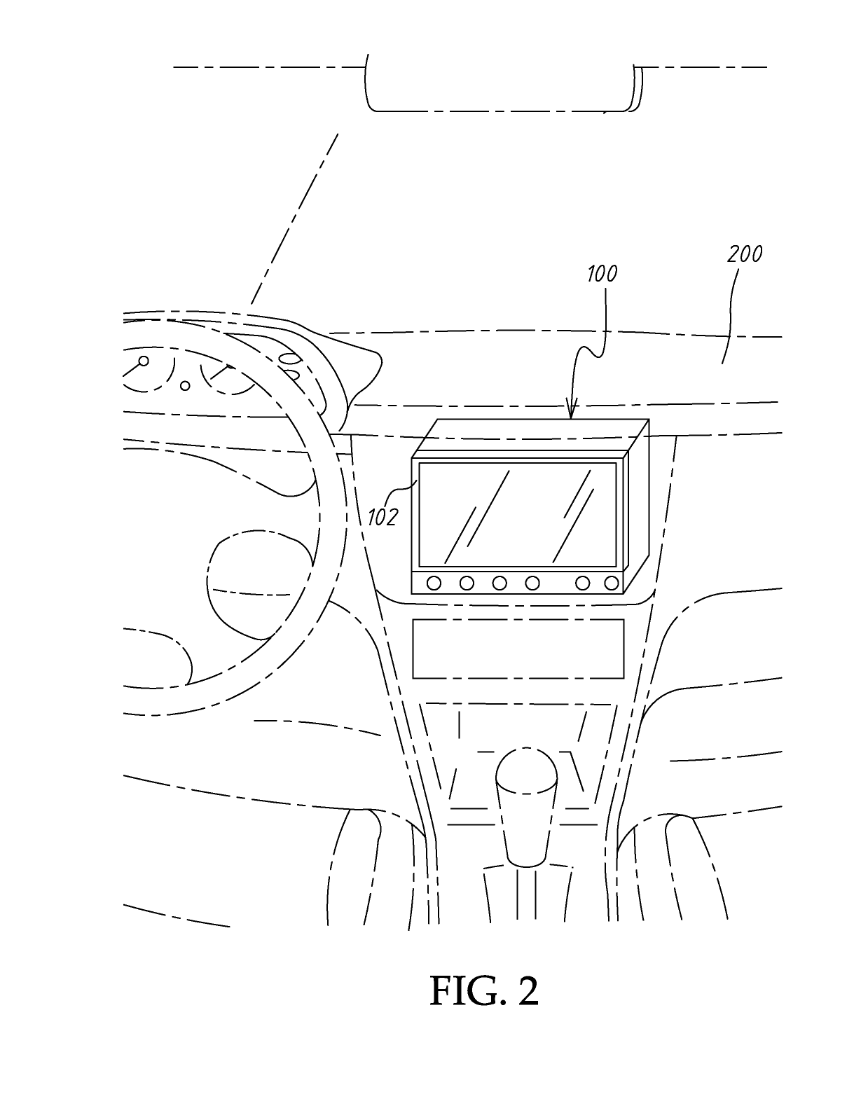

Referring to FIGS. 1 and 2, a car stereo head unit 100 in accordance with the present invention is shown installed in a dashboard center console 200 of a car. The car stereo head unit 100 comprises a control system 101, a front face panel 102, a FM/AM radio receiver module 103, a DVD/SD/USB player module 104, a digital TV receiver and player module 105, and an audio output system 106.

The control system 101 comprises a car power converter 107 electrically coupled to the car battery power supply system of the car to obtain the necessary working power supply from the car. Further, the control system 101 is electrically connected to the car control computer of the car through a linear communication system 201. The main feature of the invention is the special design of the front face panel 102. The front pace panel 102 is coupled with the control system 101, comprising a touchscreen, a display driver module system adapted for driving the touchscreen, an intelligent computer system module, an antenna embedded GPS receiver system, and a wireless communication module system.

The linear communication system 201 that electrically connects the control system 101 to the car control computer of the car is constructed subject to CAN BUS (controller area network bus) protocol. The wireless communication module system of the front pace panel 102 can be Wi-Fi/GPRS (3G/4G) wireless communication module system.

Further, the FM/AM radio receiver module 103, the DVD/SD/USB player module 104, the digital TV receiver and player module 105 and the audio output system 106 are respectively electrically coupled to the control system 101.

The audio output system 106 comprises an audio DSP (digital signal processor) system, an audio control system, and an audio power amplifier system for audio output through a speaker system 204 that is installed in the car.

Subject to touch control through the touchscreen of the front face panel 102, the control system 101 controls the audio output system 106 to play sound and the touchscreen of the front face panel 102 to play videos. Further, by means of the intelligent computer system module and wireless communication module system of the front pace panel 102, the car stereo head unit 100 is allowed for mobile phone application and internet access.

The control system 101 of the car stereo head unit 100 is also electrically coupled with a drive recorder system 202. Further, the FM/AM radio receiver module 103 is electrically coupled with a radio antenna 203.

Based on the aforesaid innovative design, the invention achieves the following applications:
A. The car stereo head unit 100 is equipped with a Wi-Fi/GPRS (3G/4G) wireless communication module system for wireless communication.
B. The car stereo head unit 100 is installed in a car, a user having a Wi-Fi/GPRS (3G/4G) PIN (personal identification number) can upload or download application software, documents or emails, and link to a cloud computing data storage system.
C. By means of linking to the intelligent computer system module and wireless communication module system of the front pace panel 102 of the car stereo head unit 100, a car security system provides a wireless car-tracking function.
D. By means of linking the intelligent computer system module and wireless communication module system of the front pace panel 102 of the car stereo head unit 100 to a host computer of a remote service center wirelessly, the remote service center can monitor the traveling of the car and directly transmit data to the car, and the car can also transmit data to the remote service center directly.
E. By means of linking the intelligent computer system module and wireless communication module system of the front pace panel 102 of the car stereo head unit 100 to a host computer of a car service center wirelessly, the car stereo head unit can provide a car location and condition information to the car service center wirelessly in case of a car failure.
F. By means of the intelligent computer system module and wireless communication module system of the front pace panel 102 of the car stereo head unit 100, the car stereo head unit 100 can transmit the recorded data from the drive recorder system 202 or real-time images being currently picked up by a web camera to a remote control center or service center wirelessly, or storing recorded image data or real-time images on a cloud server.
G. By means of the intelligent computer system module and wireless communication module system of the front pace panel 102 of the car stereo head unit 100, the car stereo head unit 100 can transmit data from the car control computer to the host system of the car service center wirelessly during a car repair and maintenance work of the car, facilitating the car repair and maintenance work.
H. The application programs installed in the car stereo head unit 100 can match with the car control computer, enabling the user to control certain functions of the car, such as the operation of the electric windows/air-conditioner, by means of the touchscreen.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A car stereo head unit installed in a dashboard center console of a car, comprising:
a control system comprising a car power converter electrically coupled to a car battery power supply system of said car to obtain the necessary working power supply from said car, and a linear communication system electrically coupled to a car control computer of said car;
a front face panel electrically coupled with said control system, said front face panel comprising a touchscreen, a display driver module system adapted for driving said touchscreen, an intelligent computer system module, an antenna embedded GPS receiver system, and a wireless communication module system;
a FM/AM radio receiver module electrically coupled to said control system;
a DVD/SD/USB player module electrically coupled to said control system;
a digital TV receiver and player module electrically coupled to said control system; and
an audio output system electrically coupled to said control system;
wherein, subject to touch control through said touchscreen of said front face panel, said control system controls said audio output system to play sound and said touchscreen of said front face panel to play videos; by means of said intelligent computer system module and wireless communication module system of said front pace panel, the car stereo head unit is allowed for mobile phone application and internet access.

2. The car stereo head unit as claimed in claim 1, wherein said linear communication system that electrically connects said control system to said car control computer of said car is constructed subject to CAN BUS (controller area network bus) protocol.

3. The car stereo head unit as claimed in claim 1, wherein said wireless communication module system of said front pace panel is a Wi-Fi/GPRS (3G/4G) wireless communication module system.

4. The car stereo head unit as claimed in claim 1, wherein said audio output system comprises an audio DSP (digital signal processor) system, an audio control system, and an audio power amplifier system for audio output through a speaker system that is installed in said car.

5. The car stereo head unit as claimed in claim 1, wherein said control system of said car stereo head unit is also electrically coupled with a drive recorder system.

6. The car stereo head unit as claimed in claim 1, wherein said FM/AM radio receiver module is electrically coupled with a radio antenna.
